(19) United States
(12) Patent Application Publication
(10) Pub. No.: US 2008/0294494 A1
(43) Pub. Date: Nov. 27, 2008

(54) Sales Order Monitoring

(75) Inventors: Susanne Ziehl, Blieskastel (DE); Thomas Weiler, Saarlouis (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/752,133

(22) Filed: May 22, 2007

(51) Int. Cl. G06F 17/30

(52) U.S. Cl. 705/10

(57) ABSTRACT

Among other things, monitoring incoming sales orders includes monitoring sales orders at one or more branches. For at least some of the sales orders a buying process is triggered. Based on one or more selection criteria, an analysis of the sales orders is performed. According to the analysis, a result list is displayed.

### TECHNICAL FIELD

The description is directed generally to sales order management, and in particular, to a method, device and computer program product for monitoring sales orders.

### BACKGROUND

Automated handling of purchase orders and sales orders is of increasing importance of today's business applications, more particularly, knowing what is sold and when it needs to be delivered is one aspect to placing orders. Furthermore, knowing what is on order and when it will arrive may be necessary. An automated system can put that information in the hands of sales people. However, today's automated sales order handling needs not only be of high-performance and work correct but should also provide process transparency, high-end usability and end-user friendliness.

### SUMMARY

Techniques for monitoring sales orders are disclosed.

In one aspect, incoming sales order are monitored. Sales orders are monitored at one or more branches. For at least some of the sales orders a buying process is triggered. Performing an analysis of the sales orders is based on one or more selection criteria. A result list corresponding to the analysis is displayed.

The subject matter described in this specification can be implemented as a method or as a device or apparatus or using computer program products, tangibly embodied in information carriers, such as a CD-ROM a DVD-ROM, a semiconductor memory, and a hard disk. Such computer program products may cause a data processing apparatus to conduct one or more operations described in this specification.

In addition, the subject matter described in this specification can also be implemented as a system including a processor and a memory coupled to the processor. The memory may encode one or more programs that cause the processor to perform one or more of the method acts described in this specification. Further the subject mailer described in this specification can be implemented using various MRI machines.

### BRIEF DESCRIPTION OF THE DRAWINGS

FIG. 1 shows a block diagram of an exemplary monitoring system.

FIG. 2 shows a flow diagram of an example method for monitoring sales orders.

FIG. 3 shows a flow diagram of exemplary further processing of a result list.

FIG. 4 shows a table of exemplary selection criteria for repotting.

FIG. 5a shows a table of an exemplary head customer order analysis.

FIG. 5b shows a table of an exemplary position customer analysts.

FIG. 5C shows a table of an exemplary for sales order positions having received articles.

FIG. 6 shows a table of an exemplary analysis for a result list.

FIG. 7 shows an exemplary computer (network) system.

Like reference symbols and designations in the various drawings indicate like elements.

### DETAILED DESCRIPTION

In the following, a detailed description of examples are given with reference to the drawings. It should be understood that various modifications to the examples may be made. In particular, elements of one example may be combined and used in other examples to form new examples.

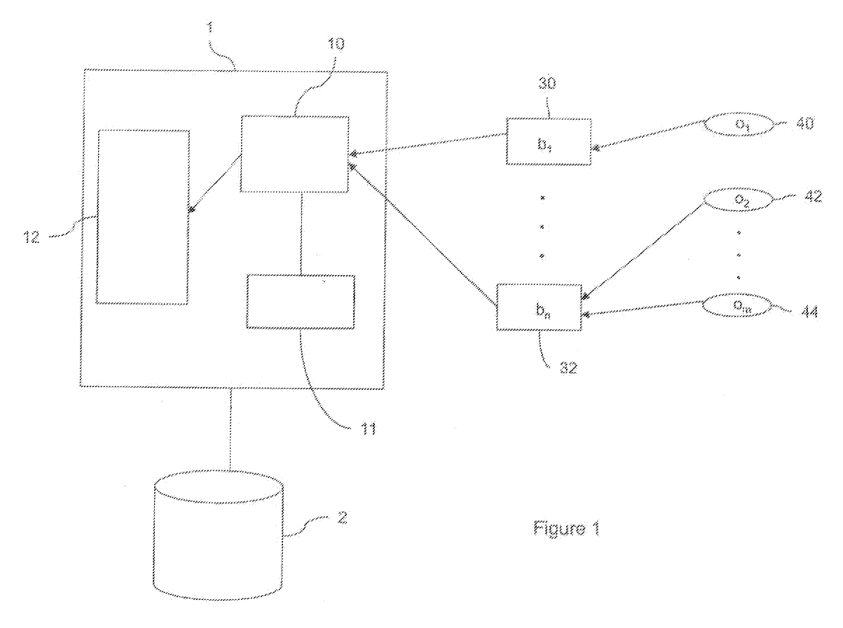

With respect to FIG. 1, an exemplary monitor device for monitoring sales orders is shown. A monitor device 1 is provided which is configured to monitor and/or manage customer orders or sales orders 40, 42, 44, for which goods or articles need to be obtained (e.g. ordered or bought) from an external unit such as an external supplier or a distribution center In other words, for the sales orders 40, 42, 44 a procurement process such as a buying process is triggered. The monitor device 1 provides a user with an overview of the sales orders 40, 42, 44, which may be arrived at one or more branches 30, 32.

In one implementation, the monitor device 1 provides a user with an overview of sales orders 40, 42, 44 for which a buying process is triggered, i.e. for which one or more articles or goods are obtained (e.g. ordered or bought) from an external unit. The one or more article may not be received at a branch 30 yet. The user may be for example a sales manager of an organization (e.g. a firm or a company) having a plurality of branches. Additionally, the monitor device 1 determines and/or identifies those of the sales orders 40, 42, 44 for which at least one of one or more articles ordered from an external unit is received at one 30 of the branches 30, 32. Furthermore, the monitor device 1 determines these of the sales order 40, 42, 44 which include articles ordered from an external unit. The articles are received at one 30 of the branches 30, 32, but are not delivered to a customer yet. In other words, the monitor device 1 identifies all articles corresponding to a sales orders 40 for which a buying process is triggered. The articles are received at one 30 of the branches 30, 32, but are not delivered to a customer having performed the order 40. A sales order 40 of a customer may include one or more positions, possibly ordered by the customer at different times. Therefore, the monitor device 1 may also determine and/or identify whether for the sales orders 40, 42, 44 each of the positions corresponding to each of the sales orders 40, 42, 44, for which a buying process is triggered, are received at one 30 of the branches 30, 32.

In one implementation, the monitor device 1 shown in FIG. 1 includes a monitoring tool 10, an analysis tool 11, and a display device 12. Furthermore, the monitor device 1 may be linked to a database or data warehouse 2. The database 2 may store and manage sales orders 40, 42, 44 The sales order may be received at one or more branches 30, 32 form one or more customers. The database 2 may maintain an ordering status corresponding to each of the sales orders 40, 42, 44. The database 2 may be a relational database such as an SAP database. The monitoring tool 10 may be linked with the analysis tool 11. The monitoring tool 10 is operable to monitor the sales orders 40, 42, 44, which are received at the one or more branches 30, 32. Furthermore, the monitoring tool 10 determines or identifies those of the sales orders 40, 42, 44 for which a procurement process (such as a buying process) is triggered. In other words, at least some of the sales orders 40, 42, 44 include at least one position for which at least one article or good needs to be provided by or obtained or bought from an external unit. The monitoring tool 10 communicates with the analysis tool 11 to receive further details about the sales orders 40, 42, 44. The analysis tool 11 includes possibly pre-defined reports (e.g. SAP reports stored in the database 2) to analyze the sales orders 40, 42, 44 and to select only those of the sales orders 40, 42, 44 which are of relevance for a user. The reports may be specified by filling in one or more specification forms with selection criteria. The selection criteria may be considered of relevance for an analysis of the sales orders 40, 42, 44 by a user. The reports may be considered as structured queries (e.g. tables) to query the database 2. Results in an analysis performed through the analysis tool 11 on the sales orders 40, 42, 44 are displayed in the display device 12 of the monitor device 1. The display device 12 may include a graphical user interlace (GUI). Results, e.g. a list of sales orders 40, 42, 44 selected through an analysis using the reports, may be displayed in a result list such as an SAP ALV (Advanced List Viewer) Grid.

In one implementation the monitor device 1 monitors sales orders 40, 42, 44, which are received at one or more branches 30, 32 using the monitoring tool 10. Each of the sales orders 40, 42, 44 may include one or more positions ordered by a customer, wherein for some of the positions a buying process is triggered. In other words, some orders 40, 42, 44 need to obtain or buy or provide one or more articles from an external unit in order to be executed. The sales orders 40, 42, 44 are analysed by the analysis tool 11. Analysis of the sales orders 40, 42, 44 may be based on one or more selection criteria. The selection criteria may be specified in one or more reports which may be used to query the database 2. The selection criteria may include one or more of the following aspects:

Selecting sales orders 40, 42, 44, for which:
a buying process is triggered, i.e. at least one article or good corresponding to an order 40 needs to be obtained or ordered from an external unit (e.g. an external supplier or a distribution center);
at least one article ordered via the buying process is received at one 30 of the branches 30, 32;
the buying process of a corresponding sales order 40 is completed; and
delivery to a customer is not carried out.
   Additional selection criteria may be defined by a user if required. One or more or the selection criteria and possible further selection criteria may be used to specify one or more reports. The one or more reports may be used to query the database 2 including sales orders 40, 42, 44, possibly additional data about the sales orders 40, 42, 44 such as a customer name, an order number, and an ordering status, and one or more older result list computed from the sales orders 40, 42, 44 based on the reports.

Based on the reports used during analysis of the sales orders 40, 42, 44, a result list is displayed to a user in the display device or unit 12 of the monitor device 1.

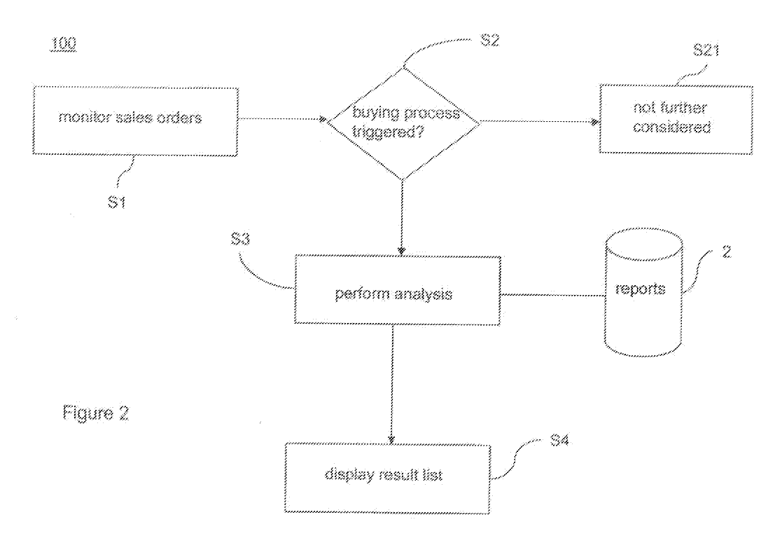

In one implementation, as shown in FIG. 2, a method 100 for monitoring sales orders 40, 42, 44 using the monitor device 1, as exemplary described above, includes monitoring S1 sales orders 40, 42 44 which are received at one or more branches 30, 32 from one or more customers and determining S2 for the sales orders 40, 42, 44, whether a procurement process (such as a buying process) is or needs to be triggered. If a buying process needs to be triggered for a sales order 40, the sales order 40 includes at least one position for which at least one article needs to be procured (e.g. obtained or ordered or bought) from an external unit (e.g. an external supplier or a distribution service). The sales order 40 may be received at one branch 30 from a customer. The branch 30 does not have the at least one article in stock. Procurement of the at least one article is necessary to complete the sales order 40. Therefore, a buying process is triggered for the sales order 40. In case, a sales order 40 is not required to be triggered by a buying process, the sales order 40 is not further considered during analysis S21. In case, a buying process needs to be triggered for a sales order 40, an analysis of the sales order 40 is performed at step S3. The analysis may be based on one or mere selection criteria. The selection criteria may determine the relevance of the sales order 40 for further monitoring. The selection criteria may be determined in one or mere specification forms such as reports. A report may be a database query according to a previously specified selection mask. The selection mask may be specified using one or more selection criteria. The reports may be performed on data relating to sales orders 40, 42, 44 stored in too database 2. Depending on the analysis, a result list of (relevant) sales orders 40, 42, 44 is displayed at step S4. The result list may be an SAP ALV Grid and may be displayed in the display unit 12 having a graphical user interface of the monitor device 1.

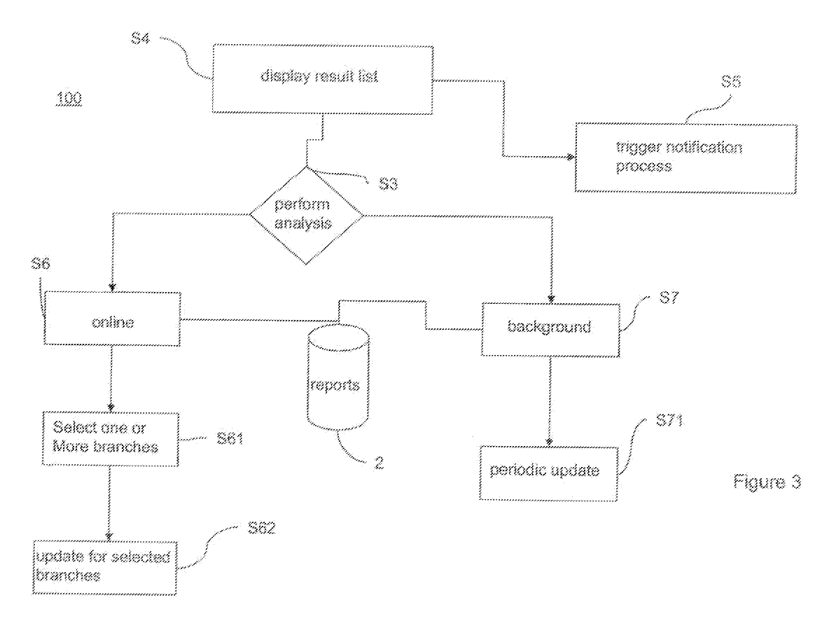

With respect to FIG. 3, one implementation of the method 100 for monitoring sales orders is shown, which may include operations in addition to those previously introduced with reference to FIG. 2. A result list of one ore more sales orders 40, 42, 44 analyzed as previously described, is displayed to a user at step S4. Depending on a result of each of the sales orders 40, 42, 44 displayed in the result list, a subsequent process may be triggered or started at step S5. In one aspect, a customer, having ordered one or more positions according to a sales order 40, may be informed by email, SMS, or any other way of notification. The notification (such as the email) may include an ordering status of the sales order 40 according to the analysis. In another aspect a customer may be informed by phone. Furthermore, depending on the result of such a subsequent process, a note for the corresponding sales order 40 of the customer may be captured and stored in the database 2 in correspondence with the sales order 40. For example, the note may include a registration that the customer was not available by phone.

In one implementation, the monitoring method 100 is performed online at step S5. In this case, a result list is displayed in an online-tool such as a browser to a user. The user may be a sales manager of a branch 30 of an organisation. The result list includes one or more sales order 40, 42, 44 determined according to an analysis (step S3) based on one or more selection criteria defined in one or more reports. The reports may be stored in the database 2 in accordance with data about the sales orders 40, 42, 44. During online analysis, the user may select at step S61 from the result list, at least one branch 30 from one or more branches 30, 32, for which the analysis has been performed. Furthermore, the user may perform an update S62 of the resell list for the selected branch 30 according to the reports. In other words, the reports are again performed on basis of the result list, but only for those sales orders 40, 42, 44 which are ordered at the selected at least one branch 30 in order to update the result list, in one aspect, an update of the result list for the at least one selected branch may be performed automatically, when the user enters his/her online analysis tool.

In one implementation, the monitoring method 100 is performed in a background application (step S7). Performing an analysis of sales orders 40, 42, 44 in a background application may include specifying one or reports according to one or mere selection criteria. The reports are stored in the database 2 in accordance with data of corresponding sales orders 40, 42, 44. The reports are periodically applied (step S71) to the sales orders 40, 42, 44 and corresponding one or more previously determined result lists in order to compute or determine an updated version of (an older version of) a result list corresponding to the sales orders 40, 42, 44. The reports may be determined by a user such as a sales manager of an organization including a plurality of branches 30, 32. The user may configure the reports by filling in one or more selection forms according to one or more selection criteria on received sales orders 40, 42, 44. After a periodic update based on a previous result list of sales orders 40, 42, 44 has been performed, a new (updated) result list may be displayed to the user.

With respect to FIGS. 4, 5a to 5c, and 6 exemplary tables of selection criteria, reports and result lists are shown. The method, device, apparatus, and system for monitoring sales orders as previously introduced with reference to FIGS. 1 to 3 may operate and depend on a database 2 such an SAP database. The database may include data on sales orders 40, 42, 44 received at one or more branches. Furthermore, the database 2 may include one or more selection criteria specified in one or more reports. The reports may be used to automatically and/or periodically or on request of a user perform an analysis on the data of the sales orders 40, 42, 44. At least one of the reports may be predefined, and stored in the database 2 along with the sales orders 40, 42, 44 and corresponding data. The database 2 may be a relational database storing data of sales orders 40, 42, 44 in tables, columns (called fields) and rows (called records or data). For example, electronically storing a telephone book in a relational database, the database may include a single table (i.e. the phone book). Within this table three fields—name, address, and telephone number may be found. Within each of these fields exists rows (or data, e.g. persons, their addressee and telephone numbers). The database 2 storing sales orders 40, 42, 40 and corresponding data received at one or more branches 30, 32 may include a plurality of tables having different numbers of fields and records (i.e. data) stored. In one aspect, data stored in accordance with sales orders 40, 42, 44 may be used as selection criteria during analysis in order to perform a recall list of relevant sales orders 40, 42. Each table in the database 2 may have a (unambiguous) name and each field of each table may have a (unambiguous) name.

In one implementation, the method 100 for monitoring sales orders, when performed in a background application, may support selection criteria such as those shown in the table of FIG. 4. That is, sales orders 40, 42, 44 may be analyzed and displayed in a result list depending on at least one of the following data stored with the sales orders 40, 42, 44 in the database 2:
a receiving date for at least one article corresponding to a sales order 40 and for which a buying process has been triggered,
a branch 30 at which at least one sales order 40 has been received from at least one customer,
the kind of an order 40,
a customer of at least one sales order 40,
a substantially unique order number of a safes order 40,
an article assigned to a safes order 40,
a class of goods at least one article belongs to, and
a desired date for delivery.

Those selection criteria are listed in the first column of the table shown in FIG. 4. Values corresponding to the selection criteria may be determined for each of the sales orders 40, 42, 44, when a sales order 40 of a customer is received at a branch 30. The values may be stored as additional data with the sales orders 40, 42, 44 in the database 2. In one implementation, a value of a sales order 40 which refers to a receiving date of at least one article corresponding the sales order 40 may be stored in a field having the name ‘MBLNR’ of a table with name ‘MKPF’ stored in the database. Similarly, values of sales orders 40, 42, 44 corresponding to each of the further selection criteria as listed above may be selected from the fields of the tables as shown in the second column of the table given in FIG. 4.

If an analysis on sales orders 40, 42, 44 is performed on all of the selection criteria, the selection may be performed by an ‘AND’-selection on the corresponding data stored for the sales orders 40, 42, 44. In other words, only those sales orders 40, 42, 44 are selected for which at least one value may be retrieved from the database 2 for each of the selection criteria. If values to the selection criteria already exist for a sales order 40 in the database, the analysis possibly performs an update of the stored value.

In addition to perform an analysis of sales orders 40, 42, 44 based on the selection criteria shown in FIG. 4, an analysis may be performed for a selected branch 30. In other words, a user of the monitor device 1 may specify a selection of at least one branch in a selection mask. A selection mask may be a table which may be filled in by a user in order to perform a query on data stored in the database 2 wherein the query is expressed in terms of a report, in other words, a filled in selection mask may be a report.

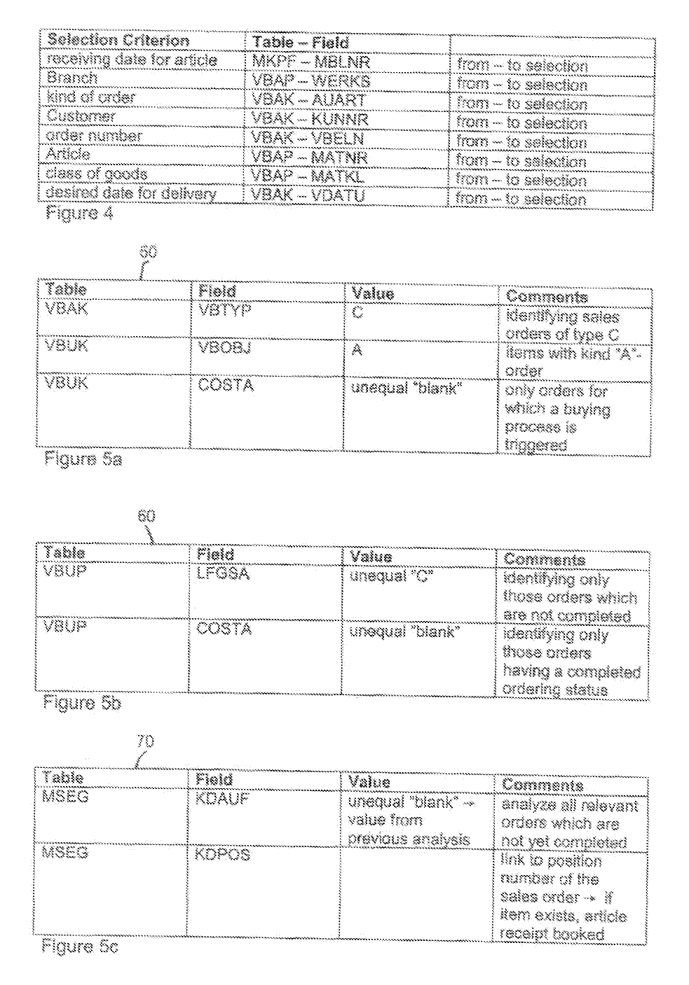

FIGS. 5a, 5b, and 5C show exemplary reports, which are used for performing an analysis S3 of sales orders 40, 42, 44. The method 100 performs an analysis S3 of sales orders 40, 42, 44 which are of relevance for a user such as a sales manager of an organization.

The table shown in FIG. 5a includes a first, report 50 to select general data form the database 2 corresponding to a sales order 40, which may be referred to as head or lead customer or sales order. The first report 50 may be used to select or retrieve those sales orders 40, 42, 44 from the database 2 for which a buying process is triggered. This may be done by
selecting from field ‘VBTYP’ of table ‘VBAK’ of the database 2 those data entries (i.e. records) having value ‘C’;
selecting from field ‘VBUK’ of table ‘VBOBJ’ of the database 2 those data entries (i.e. records) having value ‘A’; and
selecting from field ‘COSTA’ of table ‘VBUK’ of the database 2 only not
empty records (i.e. data entries having a value unequal ‘blank’).

The table shown in FIG. 5b includes a second report 60 to select data from the database corresponding to a position of a sales order 40, which may be referred to as position of sales orders. The second report 60 may be used to select or retrieve those sales orders 40, 42, 44 from the database 2 for which included positions are not completed and wherein for each of the positions included in a sales order 40 of a customer the ordering status is completed. This may be done by
selecting from field ‘LFGSA’ of table ‘VBUP’ of the database 2 those data entries (i.e. records) having a value unequal ‘C’; and
selecting from field ‘COSTA’ of table ‘VBUP’ of the database 2 only not empty records (i.e. data entries having a value unequal ‘blank’).

The table shown in FIG. 5c includes a third report 70. The third report 70 may be used to analysis whether for relevant sales orders 40, 42, 44 at least one article is received at a branch 30. Relevant sales orders 40, 42, 44 may be selected using the first report 50 and the second report 60. Thus, the third report 70 may be used to retrieve further information about the relevant sales orders 40, 42, 44 from the database 2. This may be done, by
selecting from field ‘KDAUF’ of table ‘MSEG’ the database 2 if a value entry in this field is not empty (i.e. unequal ‘blank’) then select the value retrieve within a previous analysis; and
selecting all data entries from field ‘KDPOS’ of table ‘MSEG’ of the database 2 in order to determine position numbers of positions included in each of the relevant sales orders 40, 42, 44 and to book a receipt of an article included in a position of a sales order 40.

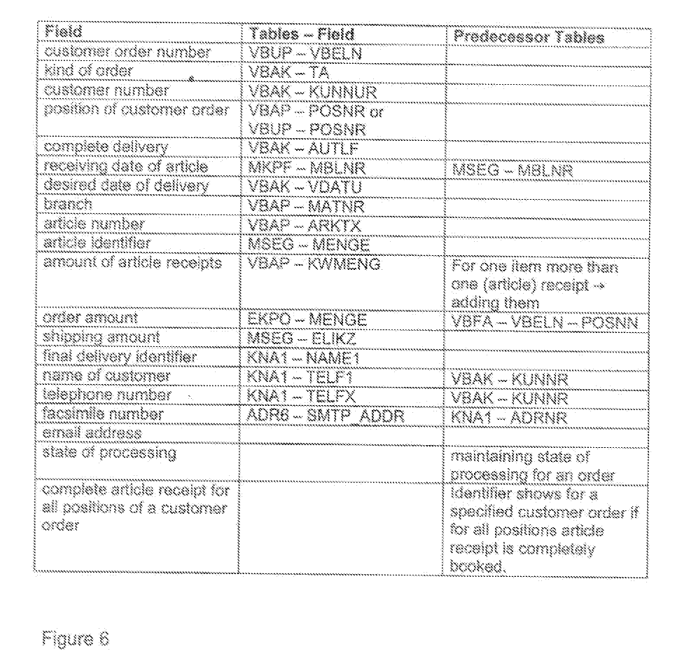

Performing an analysis (step S3) on monitored sales orders 40, 42, 44 by querying the database 2 linked with the monitor device 1 according to the first report 50, the second report 60, the third report 70 and/or further reports, fields as shown in the table of FIG. 6 may be retrieved and displayed in a result list to a user in the display unit 12 of the monitor device 1. For example, a customer order number of a sales order 40 may be retrieved from field ‘VBELN’ of table ‘VBUB’ of the database. Some of the criteria shown in the table at FIG. 6 may be retrieved from a field of a table stored in the database in view of one or more predecessor tables computed in at least one previous analysis S3 of monitored sales orders 40, 42, 44. The result list may be rendered in an ALV Grid in the display unit 12 of the monitor device 1.

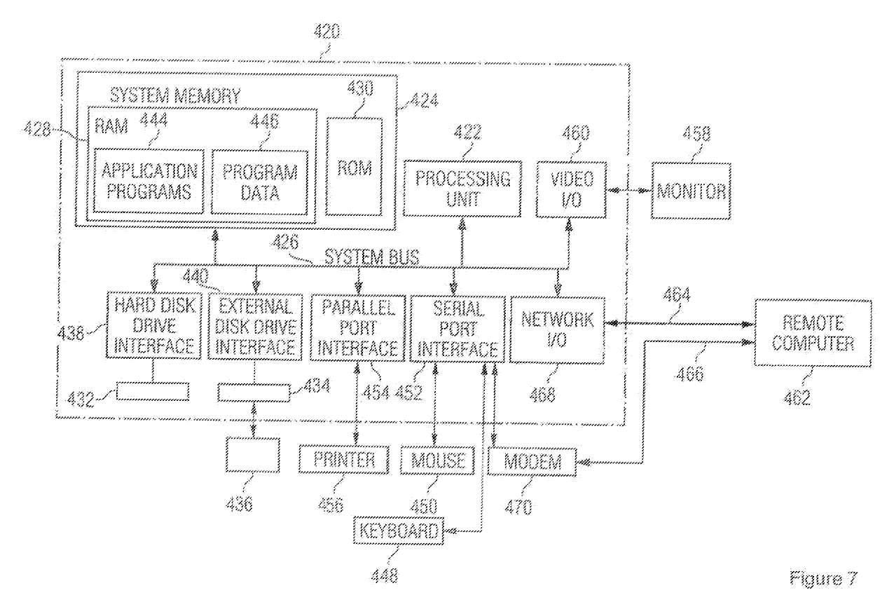

FIG. 7 shows a system for implementing the application includes a general purpose computing device in the form of a conventional computing environment 420 (e.g. personal computer), including at least one processing unit 422, a system memory 424, and a system bus 426, that couples various system components including the system memory 424 to the processing unit 422. The processing unit 422 may perform arithmetic, logic and/or control operations by accessing system memory 424. The system memory 424 may store information and/or instructions for use in combination with processing unit 422. The system memory 424 may include volatile and non-volatile memory, such as random access memory (RAM) 428 and read only memory (ROM) 430. A basic input/output system (BIOS) containing the basic routines that helps to transfer information between elements within the personal computer 420, such as during start-up, may be stored in ROM 430. The system bus 426 may be any of several types of bus structures including a memory bus or memory controller, a peripheral bus, and a local bus using any of a variety of bus architectures.

The personal computer 420 may further include a hard disk drive 432 for reading from and writing to a hard disk (not shown), and an external disk drive 434 for reading from or writing to a removable disk 436. The removable disk may be a magnetic disk for a magnetic disk driver or an optical disk such as a CD ROM for an optical disk drive. The hard disk drive 434 and external disk drive 434 are connected to the system bus 426 by a hard disk drive interface 438 and an external disk drive interface 440, respectively. The drives and their associated computer-readable media provide nonvolatile storage of computer readable instructions, date structures, program modules and other data for the personal computer 420. The data structures may include relevant data of the implementation of the alternating processing method for processing an incoming message stream 30, as described in greater detail above. The relevant data may be organized in a database, for example a relational, or object database.

Although the exemplary environment described herein employs a hard disk (not shown) and an external disk (not shown), it should be appreciated by those skilled in the art that other types of computer readable media which can store data that is accessible by a computer, such as magnetic cassettes, flash memory cards, digital video disks, random access memories, read only memories, and the like, may also be used in the exemplary operating environment.

A number of program modules may be stored on the hard disk 432, external disk, ROM 430 or RAM 428, including an operating system (not shown), one or more application programs 444, other program modules (not shown), and program data 446. The application programs may include at least a part of the functionality as detailed in FIGS. 1 to 6.

A user may enter commands and information, as discussed below, into the personal computer 420 through input devices such as keyboard 448 and mouse 450. Other input devices (not shown) may include a microphone (or other sensors), joystick, game pad, scanner, or the like. These and other input devices may be connected to the processing unit 422 through a serial port interface 452 that is coupled to the system bus 426, or may be collected by other interfaces, such as a parallel port interface 454, game port or a universal serial bus (USB). Further, information may be printed using printer 456. The printer 456, and other parallel input/output devices may be connected to the processing unit 422 through parallel port interface 454. A monitor 458 or other type of display device is also connected to the system bus 426 via an interface, such as a video input/output 460. In addition to the monitor, computing environment 420 may include other peripheral output devices (not shown), such as speakers or other audible-output.

The computing environment 420 may communicate with other electronic devices such as a computer, telephone (wired or wireless), personal digital assistant, television, or the like. To communicate, the computer environment 420 may operate in a networked environment using connections to one or more electronic devices. FIG. 7 depicts the computer environment networked with a remote computer 462. The remote computer 462 may be another computing environment such as a server, a router, a network PC, a peer device or other common network node, and may include many or all of the elements, described above relative to the computing environment 420. The logical connections depicted in FIG. 7 include a local area network (LAN) 464 and a wide area network (WAN) 466. Such networking environments are commonplace in offices, enterprise-wide computer networks, intranets and the internet.

When used in a LAN networking environment, the computing environment 420 may be connected to the LAM 464 through a network I/O 468. When used in a WAN networking environment, the computing environment 420 may include a modem 470 or other means for establishing communications over the WAN 466. The modem 470, which may be internal or external to computing environment 420, is connected to the system bus 426 via the serial port interlace 452. In a networked environment, program modules depicted relative to the computing environment 420, or portions thereof, may be stored in a remote memory storage device resident on or accessible to remote computer 462. Furthermore other data relevant to the application of the sales order monitoring method (described above) may be resident on or accessible via the remote computer 462. The data may be stored for example in an object or a relation database. It will be appreciated that the network connections shown are exemplary and other means of establishing a communications link between the electronic devices may be used.

Embodiments of the subject matter and the functional operators described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine-generated electrical, optical, or electromagnetic signal, that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated flies (e.g., flies that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital, computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device.

Computer readable media suitable for storing computer program instructions and data include all terms of eon volatile memory, media and memory devices, including by way of example semiconductor memory devices, e.g., EPROM EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a from end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The above-described, computing system is only one example of the type of computing system that may be used to automatically monitor sales orders. Other implementations, enhancements and variations can be made based on what is described and illustrated in this application.

1. A method for monitoring incoming sales orders, the method including:
monitoring sales orders at one or more branches, wherein for at least some of the sales orders a buying process is triggered;
performing an analysis of the sales orders based on one or more selection criteria; and
displaying a result list according to the analysis.

2. The method of claim 1, wherein the buying process includes: ordering at least one article from an external unit.

3. The method of claim 1, wherein the one or more selection criteria include: selecting at least one of the sales orders for which at least one article is ordered via the buying process.

4. The method of claim 3, wherein the one or more selection criteria include: selecting at least another of the sales orders for which at least one article, ordered via the buying process, is received at one of the one or more branches.

5. The method of claim 4, wherein the one or mere selection criteria include: selecting at least a further of the sales orders for which the buying process is complete.

6. The method of claim 1, further including; performing the analysis in a background application.

7. The method of claim 6, further including: specifying at least one report including at least one of the one or more selection criteria.

8. The method of claim 7, further including: periodically applying the at least one report to the sales orders and updating the corresponding result list.

9. The method of claim 1, further including: performing the analysis online.

10. The method of claim 9, further including: selecting at least one of the one or more branches from the result list.

11. The method of claim 10, further including: updating the result list for the selected at least one branch.

12. The method of claim 1, wherein the result list includes an ordering status for at least one of the sales orders.

13. The method of claim 12, further including: starting a subsequent process according to the ordering status.

14. A method for monitoring a buying process, the method including:
identifying one or more sales orders for which the buying process is triggered, wherein at least one of the one or more sales orders includes at least one article received at a branch from an external unit and the one or more, sales orders are not completed; and
displaying the one or more sales orders on a monitor device.

15. A computer program product, embodied in a computer-readable medium, operable to cause a data processing apparatus to perform operations according to the method of claim 1.

16. A monitor device including:
a monitoring tool operable to monitor sales orders received at one or more branches, wherein for at least some of the sales orders a buying process is triggered;
an analysis tool operable to perform an analysis of the sales orders based on one or mere selection criteria; and
a display unit operable to display a result list according to the analysis.

17. The device of claim 16, wherein the one or mere selection criteria include: a first selection criterion to select at least one of the sales orders for which at least one article is ordered via the buying process.

18. The device of claim 17, wherein the one or mere selection criteria include: a second selection criterion to select at least another of the sales orders for which at least one article, ordered via the buying process, is received at one of the one or more branches.

19. The device of claim 18, wherein the one or more selection criteria include: a third selection criterion to select at least a further of the sales orders for which the buying process is complete.

20. The device of claim 16, wherein the analysis is performed in a background application which is operable to periodically update the result list according to the one or more selection criteria.

21. The device of claim 16, wherein the analysis is performed online.

22. An apparatus including:
means for monitoring sales orders at one or more branches, wherein for at least some of the sales orders a buying process is triggered;
means for performing an analysis of the sales orders based on one or more selection criteria; and
means for displaying a result list according to the analysis.

23. An apparatus including:
means for identifying one or more sales orders for which the buying process is triggered, wherein at least one of the one or more sales orders includes at least one article received at a drench from an external unit and the one or more sales orders are not completed; and
means for displaying the one or more sales orders on a monitor device.
